(19) United States
(12) Patent Application Publication
(10) Pub. No.: US 2011/0251322 A1
(43) Pub. Date: Oct. 13, 2011

(54) NON-BENZENE ADHESIVE AND MANUFACTURING PROCESS THEREOF

(76) Inventor: HUNG-CHE LEE, Taipei City (TW)

(21) Appl. No.: 13/165,809

(22) Filed: Jun. 22, 2011

Related U.S. Application Data
(63) Continuation-in-part of application No. 12/418,617, filed on Apr. 6, 2009.

(51) Int. Cl. C08K 5/101

(52) U.S. Cl. 524/315

(57) ABSTRACT

The present invention relates to a non-benzene adhesive and a manufacturing process thereof. The process includes: mixing a mixed solvent including 50 wt % of methylcyclohexane (MCH), 30 wt % of n-propyl acetate (NPAC) and 20 wt % of methyl ethyl ketone (MEK) with a first natural rubber, then mixing the mixture with a monomer under a heating condition; adding a thermal initiator to carry out a thermal polymerization reaction; stopping the thermal polymerization reaction with a terminator; adding a vulcanization accelerator after cooling down to produce a liquid semi-finished product; subsequently firstly mixing the semi-finished product with the MCH and the NPAC, then adding a second natural rubber; and continuously and successively adding the NPAC while maintaining a stirring and flowing state, so as to produce an industrial non-benzene adhesive including no benzene components for applying in pasting different kinds of shoes, without compromising the stickiness of the adhesive.

### CROSS-REFERENCE

This is a continuation in part of the co-pending patent application Ser. No. 12/418,617, filed Apr. 6, 2009.

### BACKGROUND OF THE INVENTION

1. Field of the Invention

The invention relates to a production field of industrial adhesives, and particularly relates to produce an industrial non-benzene adhesive and a manufacturing process thereof without using a solvent having benzene, methylbenzene and dimethylbenzene.

2. Description of the Prior Art

During a manufacturing process of current commercially-available industrial adhesives (such as super adhesive and bond adhesive), the material is mixed with a benzene organic mixed solvent (including benzene, methylbenzene, dimethylbenzene and the like), wherein the benzene organic mixed solvent can release toxic benzene gas with aromatic odor. Benzene poisoning causes irritation on skin, eyes and upper respiratory tract, and causes diseases such as allergic dermatitis, laryngeal edema, bronchial diseases and thrombocytopenia. Long-term inhalation of toxic benzene gas can further cause aplastic anemia, leukaemia and even abnormal menstruation. According to statistics, if contacting with toxic benzene during pregnancy, the incidence rate of pregnancy complications is significantly increased, and if women inhales large amounts of toxic benzene during pregnancy, the firstborn may be caused to have defects such as microcephaly, central nervous system dysfunction and growth retardation. Thus benzene compounds have been defined as strong carcinogenic substances by World Health Organization.

Accordingly, in recent years, the application of benzene-containing mixed solvents and benzene-containing adhesives is decreasing year by year. People are looking for more alternative schemes to decrease the incidence rate of benzene poisoning. As an example, in the footwear industry, the industrial adhesive for pasting the surfaces and soles of shoes can be divided into two kinds, the vulcanized adhesive (which should be heated to about 120° C. and maintained for about 70 minutes after jointing) and the cold assembly adhesive, strict rules have been established for contents of toxic substances such as benzene, methylbenzene and dimethylbenzene, so as to ensure the safety of operators and consumers during production and utilization.

Moreover, since common commercially-available industrial adhesives complying with specifications of non-benzene adhesives mostly often have a disadvantage of poor stickiness, the inventor produces a semi-finished product through a manufacturing process using a natural rubber and a mixed solvent including methylcyclohexane (MCH), n-propyl acetate (NPAC) and methyl ethyl ketone (MEK), and then performs a mixing process using the semi-finished product and a natural rubber, so as to produce a non-benzene adhesive complying with national standards and meeting the demands of customers, wherein the adhesive is indeed proved to have good stickiness through testing.

### SUMMARY OF THE INVENTION

One purpose of the present invention is to provide a manufacturing process of a non-benzene adhesive, so as to produce an industrial adhesive with low toxicity and with no influence on stickiness for pasting, which complies with national standards and can meet the demands of customers.

In order to achieve the above goal, the manufacturing process of the non-benzene adhesive includes the following steps: provides a first natural rubber and a mixed solvent including 50 wt % of MCH, 30 wt % of NPAC and 20 wt % of MEK; mixes the first natural rubber within the mixed solvent to produce a mixture; heats the mixture to 70° C., dissolves a monomer with the mixture to produce raw materials; heats the raw materials to 75-80° C., adds a thermal initiator to carry out at least one thermal polymerization reaction; adds a terminator to stop the thermal polymerization reaction, cool the raw materials down to 60° C.; mixes a vulcanization accelerator to produce a liquid semi-finished product; mixes the semi-finished product with MCH and NPAC to produce a semi-finished product solution; and then mixes a second natural rubber into the semi-finished product solution, continuously and successively adds NPAC during the mixing process to produce a non-benzene adhesive to comply with the national safety standards and meeting the demands of customers.

Wherein, the thermal polymerization reaction is operated twice in conditions of maintaining at the same temperature to significantly improve the polymerization effects.

Wherein, the first natural rubber and the second natural rubber are air-dried rubber.

Wherein, the monomer mixture includes methyl methacrylate (MMA) and n-butyl methacrylate (NBMA).

Wherein, the thermal initiator is benzoylperoxide (BPO).

Another purpose of the present invention is to provide a non-benzene adhesive including no toxic benzene component through the above manufacturing process without influence the stickiness of the adhesive.

To achieve the above goal, the non-benzene adhesive includes the following components: 60-70 wt % of NPAC, 25-35 wt % of MCH, 5-15 wt % of MEK and a natural rubber.

Accordingly, the non-benzene adhesive of the present invention mainly uses the MCH, which is a product produced from methylbenzene through a series of reactions and can be used as a solvent due to the similar characteristics to that of the methylbenzene. As is known after practical verification, the MCH has the same excellent dissolving effect as methylbenzene. However, the non-benzene adhesive directly produced from the MCH has poor bonding strength, so that the NPAC is added to improve the bonding strength of the non-benzene adhesive. Finally, the MEK is added to adjust the volatilization speed of the non-benzene adhesive.

### BRIEF DESCRIPTION OF THE DRAWINGS

FIG. 1 is a production flow chart in accordance with a preferred embodiment of the present invention;

FIG. 2 is an ingredient proportion table of the mixed solvent used in the first stage of manufacturing process in accordance with a preferred embodiment of the present invention; and

FIG. 3 is an ingredient proportion table of the non-benzene adhesive completed in the second stage of the manufacturing process in accordance with the preferred embodiment of the present invention.

### DETAILED DESCRIPTION OF THE PREFERRED EMBODIMENTS

In order to make it convenient for a patent examiner to know about the content of the present invention clearly, the present invention will be described in details with reference to the following description and the accompanying drawings

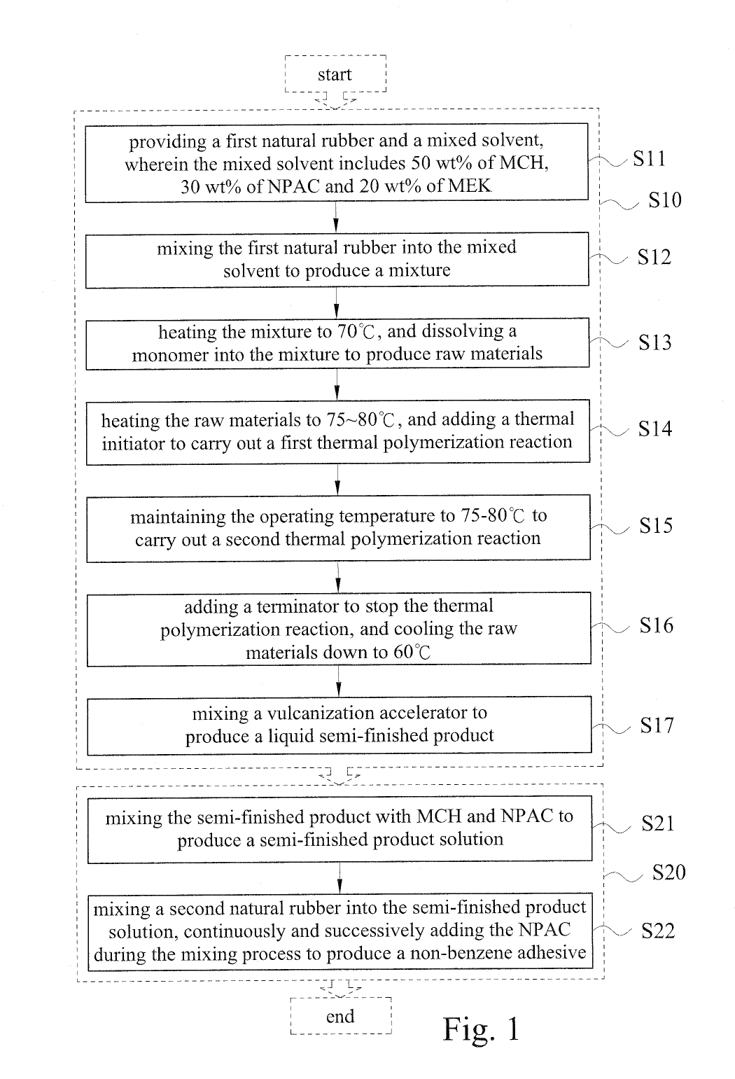

Refer to FIG. 1, which is a manufacturing flow chart in accordance with a preferred embodiment of the present invention. As shown in the figure, the present invention is mainly divided into two stages, wherein a semi-finished product is produced at the first stage, and then a non-benzene adhesive 1 is finally produced from the semi-finished product at the second stage.

The first stage of manufacturing process S10 (also referred to as a thermal polymerization process) includes:

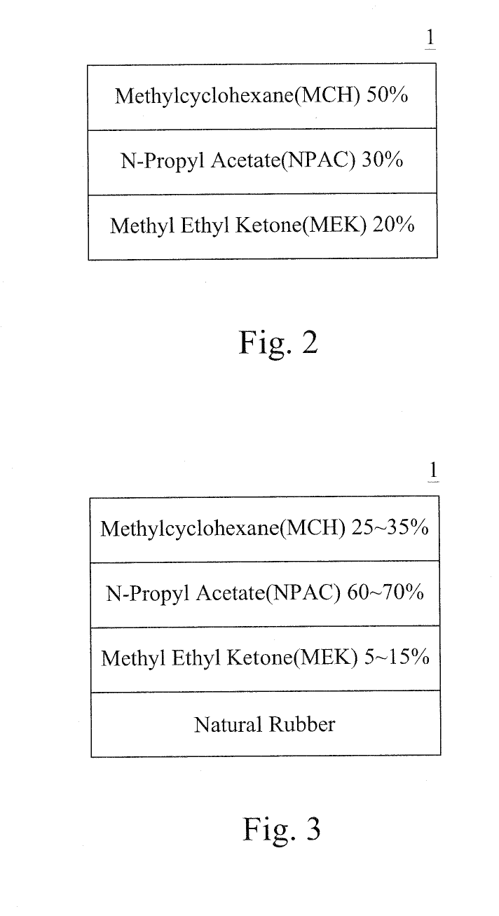

S11: providing a first natural rubber and a mixed solvent, wherein the mixed solvent includes 50 wt % of methylcyclohexane (MCH), 30 wt % of n-propyl acetate (NPAC) and 20 wt % of methyl ethyl ketone (MEK), and further refer to FIG. 2, which is an ingredient proportion table of the mixed solvent used in the first stage of manufacturing process of a preferred embodiment of the present invention;

S12: mixing the first natural rubber into the mixed solvent to produce a mixture;

S13: heating the mixture to 70° C., and dissolving a monomer into the mixture to produce raw materials. It should be noted that the ingredients of the monomer mainly used in the present invention are MMA and NBMA, and chemical materials with the same characteristics can also be used without limitation. However, the chemical materials mentioned above are experimented and preferred by inventors;

S14: heating the raw materials to 75-80° C., and adding a thermal initiator to carry out a first thermal polymerization reaction, wherein after adds the thermal initiator into the raw materials, the operating temperature should be maintained at 75-80° C. to carry out a continuous thermal polymerization reaction on the raw materials, and the thermal initiator used in the present invention is a common thermal initiator—BPO, which can be replaced by other thermal initiators, and it should be noted that the operating temperature of 75˜80° C. is the preferred operating temperature obtained through experiments, while thermal polymerization reaction failure caused by overreaction due to carelessness and operating temperature change caused by ingredient proportion change of the mixed solvent will not be discussed here;

S15: maintaining the temperature of 75-80° C. to carry out a second thermal polymerization reaction, wherein after four hours of the first thermal polymerization reaction, maintaining the temperature of 75-80° C. and adding appropriate amounts of the thermal initiator again to carry out another thermal polymerization reaction over four hours. The thermal polymerization effect is optimal after processing two times of thermal polymerization reactions according to the experiments by the inventor;

S16: adding a terminator to stop the thermal polymerization reaction, and cooling the raw materials down to 60° C.; and

S17: mixing a vulcanization accelerator to produce a liquid semi-finished product.

The second stage of the manufacturing process S20 should only proceed until the production of the semi-finished product is completed, the second stage includes:

S21: mixing the semi-finished product with MCH and NPAC to produce a semi-finished product solution, wherein the semi-finished product solution is obtained by mixing the liquid semi-finished product, the MCH and the NPAC; and

S22: mixing a second natural rubber into the semi-finished product solution, continuously and successively adding the NPAC in the mixing process to produce a non-benzene adhesive 1. It should be noted that a solid natural rubber and a mixed natural rubber are used in the present invention, and the NPAC is continuously and successively added in the mixing process, it is the key point of the present invention to avoid the solubility interference of the natural rubber in the MCH caused by adding large amounts of NPAC at a time, which would otherwise cause the failure of the whole manufacturing process.

Turn to FIG. 3, which is an ingredient proportion table of the non-benzene adhesive 1 completed in the second stage of the manufacturing process of the preferred embodiment of the present invention. As shown in the figure, the mixed solvent including 50 wt % of MCH, 30 wt % of NPAC and 20 wt % of MEK is used in the first stage of the manufacturing process, the MCH and the NPAC are added again in the second stage of the manufacturing process, and a natural rubber is added in both stages of the manufacturing process. Thus the main ingredients of the non-benzene adhesive 1 consists of 60-70 wt % of NPAC, 25-35 wt % of MCH, 5-15 wt % of MEK and the natural rubber.

As mentioned above, the MCH used in the present invention is produced through a hydrogenation reaction on the methylbenzene, so that the content of methylbenzene within the non-benzene adhesive 1 is not zero completely. However, on the whole, the contents of benzene, methylbenzene and dimethylbenzene within the adhesive are all below the safety content complying with the national safety standards and meeting the demands of customers, and since the rubber used during the manufacturing process is the natural rubber, the safety in utilization is significantly increased with good stickiness after agglutination.

The content mentioned is only a preferred embodiment of the present invention, and is not intended to limit the implementation scope of the present invention. Other things such as changing types of chemical substances such as the natural rubber, the monomer, the thermal initiator, the terminator and the vulcanization accelerator are also within the scope of the present invention. Thus, through equivalent or slight changes made in type selecting among chemical substances with the same characteristics, equivalent variations and modifications made within the spirit and scope of the present invention by those skilled in the chemical art are all within the patent scope of the present invention.

From the above, the non-benzene adhesive and the manufacturing process thereof provided by the present invention have characteristics of patent invention and industrial utility value. Thus, according to provisions of the patent law, the applicant submits a patent invention application to the patent office.

What is claimed is:

1. A manufacturing process of a non-benzene adhesive, comprising:
providing a first natural rubber and a mixed solvent, the mixed solvent comprising 50 wt % of methylcyclohexane (MCH), 30 wt % of n-propyl acetate (NPAC) and 20 wt % of methyl ethyl ketone (MEK);
mixing the first natural rubber into the mixed solvent to produce a mixture;
heating the mixture to 70° C., and dissolving a monomer into the mixture to produce raw materials;
heating the raw materials to 75˜80° C., and adding a thermal initiator to carry out at least one thermal polymerization reaction;
adding a terminator into the raw materials to stop the thermal polymerization reaction, and cooling the raw materials down to 60° C.;
mixing a vulcanization accelerator into the raw materials to produce a liquid semi-finished product;
mixing the semi-finished product with methylcyclohexane (MCH) and n-propyl acetate (NPAC) to produce a semi-finished product solution; and
mixing a second natural rubber into the semi-finished product solution, continuously and successively adding n-propyl acetate (NPAC) during the mixing process to produce a non-benzene adhesive.

2. The manufacturing process of the non-benzene adhesive of claim 1, wherein the thermal polymerization reaction is operated twice in conditions of maintaining at the same operating temperature.

3. The manufacturing process of the non-benzene adhesive of claim 1, wherein the first natural rubber and the second natural rubber are air-dried rubber.

4. The manufacturing process of the non-benzene adhesive of claim 1, wherein the monomer mixture comprises methyl methacrylate (MMA) and n-butyl methacrylate (NBMA).

5. The manufacturing process of the non-benzene adhesive of claim 1, wherein the thermal initiator is benzoylperoxide (BPO).

6. A non-benzene adhesive produced according to the manufacturing process of the non-benzene adhesive of claim 1, comprising:
60-70 wt % of n-propyl acetate (NPAC);
25-35 wt % of methylcyclohexane (MCH);
5-15 wt % of methyl ethyl ketone (MEK); and
a natural rubber.
